(19) United States
(12) Patent Application Publication
(10) Pub. No.: US 2025/0026273 A1
(43) Pub. Date: Jan. 23, 2025

(54) FOOTSTEP ASSEMBLY FOR A VEHICLE

(71) Applicant: Volvo Truck Corporation, Göteborg (SE)

(72) Inventors: David MAIRE SEBILE, St Etienne Du Bois (FR); Arthur LE GALL, Plougastel Daoulas (FR); Denis BERNARD, Göteborg (SE)

(21) Appl. No.: 18/765,681

(22) Filed: Jul. 8, 2024

(30) Foreign Application Priority Data
Jul. 17, 2023 (EP) 23185850.7

(51) Int. Cl. B60R 3/02

(52) U.S. Cl. CPC B60R 3/02

(57) ABSTRACT

A footstep assembly for a vehicle, such as a truck, comprising a main frame configured to be coupled on a chassis of the vehicle; a fastening device adapted to fasten the main frame to the chassis of the vehicle, preferably directly below an existing sidestep of the vehicle; at least one step hingedly connected to the main frame through an articulated mechanism, the articulated mechanism having a folded state, in which the at least one step is in a storage position, in which it is aligned in a first horizontal plane, and an unfolded state, in which the at least one step is in an operative position, in which it is aligned in second horizontal plane that is below the first horizontal plane and vertically offset therefrom; an actuator configured to switch the articulated mechanism between its folded state and unfolded state; and a controller adapted to control the actuator.

### PRIORITY APPLICATIONS

The present application claims priority to European Patent Application No. 23185850.7, filed on Jul. 17, 2023, and entitled “FOOTSTEP ASSEMBLY FOR A VEHICLE,” which is incorporated herein by reference in its entirety.

### TECHNICAL FIELD

The disclosure relates generally to a structure helping the passengers of a vehicle to access to the vehicle passenger area. In particular aspects, the disclosure relates to a footstep assembly for a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Due to their height, trucks and other heavy vehicles are commonly provided with footsteps to permit to a user to enter the cab or cargo area of the vehicle.

These footsteps are generally mounted on both sides of the cab and may comprise one or several steps. However, these steps are generally spaced apart a large vertical distance from the ground making it physically challenging to climb up and into the vehicle. A user having a small stature or suffering from a physical disability or injury may thus find it impossible to get in and out of such vehicles. A solution to this problem may consist in providing permanent ladders. However, these permanent ladders reduce the overall ground clearance which may impact negatively on the aerodynamics of the vehicle.

### SUMMARY

According to a first aspect of the disclosure, the disclosure relates to a footstep assembly for a vehicle, such as a truck, comprising:
a main frame configured to be coupled on a chassis of the vehicle,
a fastening device adapted to fasten the main frame to the chassis of the vehicle, preferably directly below an existing sidestep of the vehicle,
at least one step hingedly connected to the main frame through an articulated mechanism, the articulated mechanism having a folded state, in which the at least one step is in a storage position, in which it is aligned in a first horizontal plane, and an unfolded state, in which the at least one step is in an operative position, in which it is aligned in second horizontal plane that is below the first horizontal plane and vertically offset therefrom,
an actuator configured to switch the articulated mechanism between its folded state and its unfolded state
a controller adapted to control the actuator.

Thus configured, the footstep assembly of the disclosure provides an additional step that can be moved from a storage position, in which the step is substantially hidden under an existing sidestep of the vehicle, into an operative position, in which the additional step extends downwardly from the chassis of the vehicle and provides a support for the feet of a passenger that is closer from the ground than the existing sidestep, thus enabling passengers to obtain easy ingress and egress to and from the passenger area. This footstep assembly may advantageously be mounted below an existing sidestep of a conventional truck. The footstep assembly of the disclosure thus provides a simple and cheaper solution to the problem of accessing to the passenger area of a vehicle for a person having a small stature or suffering from a physical disability or injury.

Optionally in some examples, including in at least one preferred example, the at least step comprises a tread, on which one can place a foot, and an extension bracket extending rearward therefrom and the articulated mechanism comprises a parallelogram arrangement comprising two pairs of support links, respectively a first pair of front support links and a second pair of rear support links, the front, respectively the rear, support links being pivotally fixed at their upper ends to the main frame and at their lower ends to the extension bracket.

Optionally in some examples, including in at least one preferred example, the rear support links are fixedly connected to a connecting rod pivotally fixed to the main frame, said connecting rod being rotatably movable about a rotation axis through a motor.

Optionally in some examples, including in at least one preferred example, the motor is electric.

Optionally in some examples, including in at least one preferred example, the footstep assembly further comprises at least one sensor adapted to sense the current position of the at least one step and transmit a corresponding signal to the controller so that the controller stops the actuator when the at least one step is in its storage and/or operative position(s).

Optionally in some examples, including in at least one preferred example, the footstep assembly further comprises a magnet adapted to interact with a metallic portion of the articulated mechanism when the at least one step is in its storage position so that the articulated mechanism is kept in its folded state.

Optionally in some examples, including in at least one preferred example, the fastening device comprises a plurality of screws that are received in corresponding holes of the main frame and adapted to be screwed into corresponding threaded holes of the chassis of the vehicle.

Optionally in some examples, including in at least one preferred example, the controller is adapted to be electrically connected to an electronic control unit of the vehicle so as to receive control signals therefrom.

Optionally in some examples, including in at least one preferred example, the controller is adapted to switch the articulated mechanism from its folded state to its unfolded state when it receives a specific control signal from the electronic control unit of the vehicle.

According to a second aspect of the disclosure, the disclosure relates to a vehicle comprising:
an electronic control unit,
a cab including at least one cab door and at least one side footstep below said at least one cab door,
a door sensor adapted to sense an opening/closing state of the at least one cab door and transmit a corresponding signal to the electronic control unit,
a footstep assembly according to any of the embodiments set forth herein above mounted on the at least one side footstep,
   wherein the electronic control unit is adapted to transmit a specific control signal to the controller of the footstep assembly when it receives a signal from the door sensor when the at least one cab door opens, thus moving the at least one step of the footstep assembly from its storage position to its operative position, and/or when the at least one cab door closes, thus moving the at least one step of the footstep assembly from its operative position to its storage position.

Thus configured, the vehicle of the disclosure provides an additional step that can enable passengers to obtain easy ingress and egress to and from the passenger area as soon as the passenger opens/closes the cab door, thus avoiding the need of a specific command unit to actuate by the passenger to position the additional step in its operative/storage position.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended

### DRAWINGS

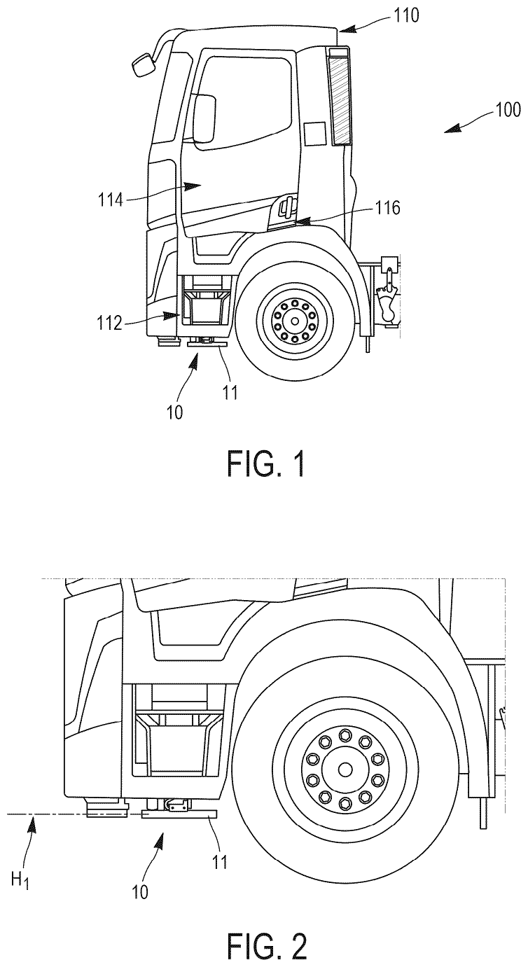

FIG. 1 is a perspective view of a cab of a truck equipped with a footstep assembly according to the present invention, the footstep assembly being shown in its fully retracted state.

FIG. 2 is an enlarged view of the footstep assembly shown in FIG. 1.

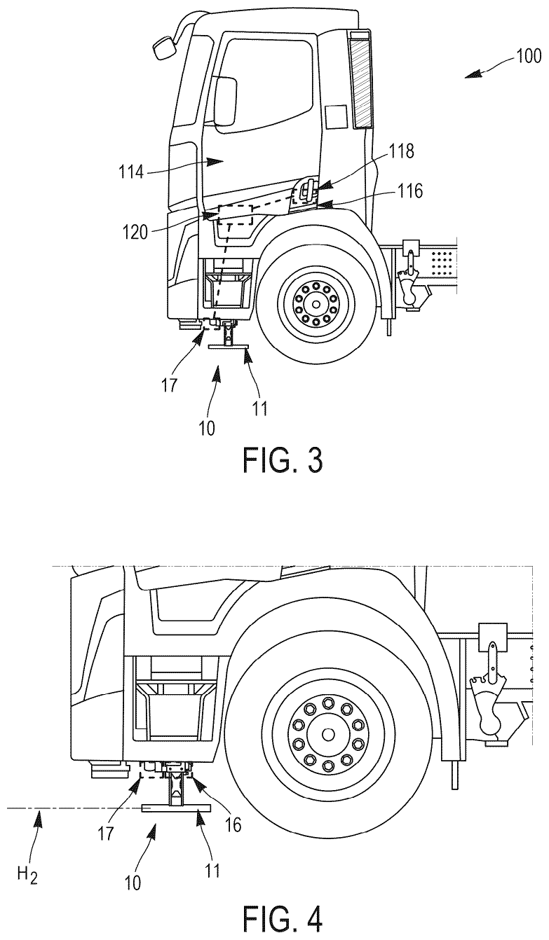

FIG. 3 is a view similar to FIG. 1, the footstep assembly being shown in its fully extended state.

FIG. 4 is an enlarged view of the footstep assembly shown in FIG. 3.

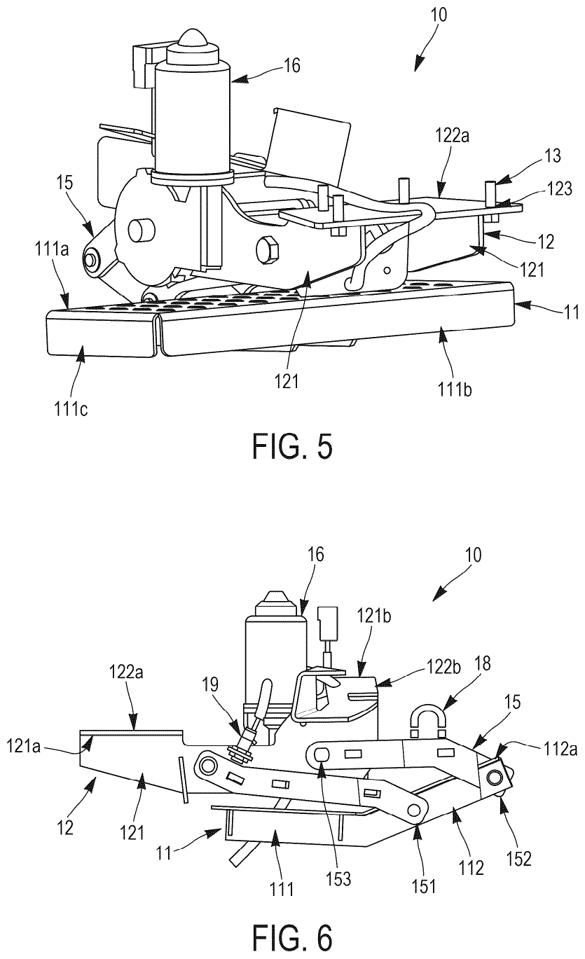

FIG. 5 is a perspective view of a footstep assembly according to one preferred embodiment of the present invention, the footstep assembly being shown in its fully retracted state.

FIG. 6 is a side view of the footstep assembly illustrated in FIG. 5.

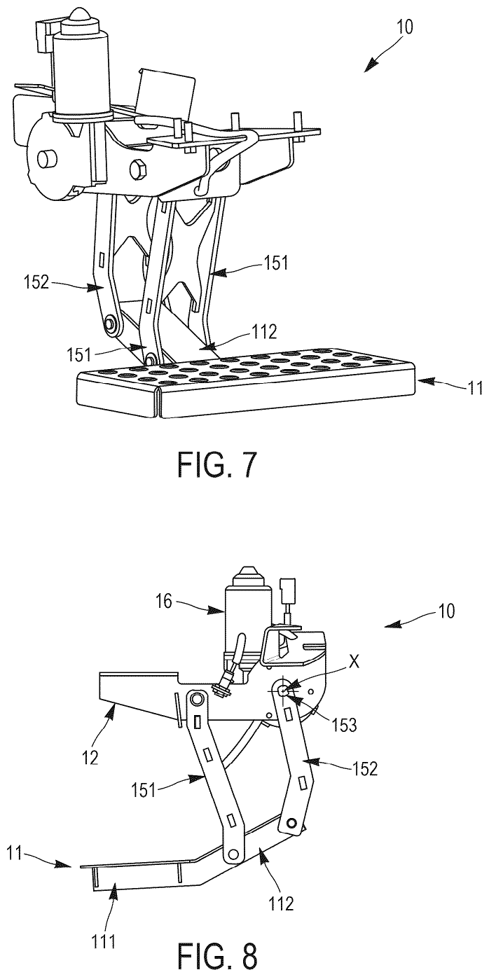

FIG. 7 is a view similar to FIG. 5, the footstep assembly being shown in its fully extended state.

FIG. 8 is a side view of the footstep assembly illustrated in FIG. 7.

### DETAILED DESCRIPTION

The detailed description set forth below provides information and examples of the disclosed technology with sufficient detail to enable those skilled in the art to practice the disclosure.

FIG. 1 shows a cab 110 of a truck 100 provided with a footstep assembly 10 according to the invention. The footstep assembly 10 is mounted below an existing sidestep 112 that is below a cab door 114. The footstep assembly 10 comprises in particular a step 11. The cab door 114 allows a passenger to access to an internal area of the cab 110 when it is opened, for example, when a user acts on a door handle 116. The existing sidestep 112 is however relatively far from the ground, thus making it physically challenging to climb up and into the vehicle for the passenger.

The foot assembly 10 illustrated in FIG. 1, and best seen in FIG. 2, is in a fully retracted state. In this state, the step 11 of the footstep assembly 10 is in a storage position, in which it is aligned in a horizontal plane H1, close to the chassis of the truck 100, the size of the footstep assembly 10 under the chassis of the truck 100 being the lowest possible. However, in this storage position, the step 11 is relatively far from the ground. A passenger wishing to access to the internal area of the cab 110 may thus have the same difficulties to climb up as in a conventional truck.

The truck 100 may advantageously comprise a system adapted to transfer the footstep assembly 10 from its fully retracted state to a fully extended state illustrated in FIG. 3 and FIG. 4.

In this fully extended state, the step 11 of the footstep assembly 10 is in an operative position, in which it is aligned in a horizontal plane H2 that is below the horizontal plane H1 and vertically offset therefrom, thus greatly reducing the distance between the step 11 and the ground. A passenger wishing to access to the internal area of the cab 110 may thus have less difficulties to climb up as in a conventional truck.

The transfer of footstep assembly 10 from its fully retracted state to its fully extended state may be triggered by an action of the passenger on a door handle 116 that is positioned in a lower part of the cab door 114. The passenger may thus act on the door handle 116 to open the cab door 114. This action may be detected by a specific sensor 118 mounted in the cab door 114. The sensor 118 may be electrically connected to an electronic control unit (ECU) 120 of the truck 100 and may thus send a specific signal to the ECU 120 indicating that the cab door 114 has been opened. The ECU 120 is adapted to transmit a specific control signal to a controller 17 integrated in the footstep assembly 10 when it receives said specific signal from the sensor 118. The controller 17 is adapted to control an actuator 16 integrated in the footstep assembly 10 when it receives said specific control signal from the ECU 120, the actuator 16 being configured to move the step 11 from its storage position to its operative position.

In the same way, the transfer of footstep assembly 10 from its fully extended state to its fully retracted state may be triggered by an action of the passenger on a door handle 116 to close the cab door 114. This closure may be detected by the sensor 118. The sensor 118 may thus send a specific signal to the ECU 120 indicating that the cab door 114 has been closed. The ECU 120 is adapted to transmit a specific control signal to the controller 17 when it receives said specific signal from the sensor 118. The controller 17 is adapted to control the actuator 16 when it receives said specific control signal from the ECU 120, the actuator 16 thus moving the step 11 from its operative position to its storage position.

A footstep assembly 10 according to one preferred embodiment of the present invention is respectively illustrated in FIG. 5 and FIG. 6, in in its fully retracted state, and in FIG. 7 and FIG. 8, in its fully extended state. The footstep assembly 10 comprises a main frame 12 on which a single step 11 is supported by an articulated mechanism 15, for controlling coordinated movement between a retracted condition, shown in FIGS. 5 and 6, wherein the step 11 is withdrawn just under the frame 12 for storage and a fully extended condition, shown in FIGS. 7 and 8, wherein the step 11 is disposed downwardly from the retracted condition for use.

As shown in FIGS. 5 and 6, the frame 12 basically comprises a pair of vertically extending flat rigid end plates 121, each having respective front and rear upper edges 121a and 121b, supported in spaced facing mirror image relation, the end plates 121 being connected by a front transverse crossbar 122a extending laterally between and fixed at their opposite ends to the respective front upper edges 121a of the end plates 121 and by a rear transverse crossbar 122b extending laterally between and fixed at their opposite ends to the respective rear upper edges 121b of the end plates 121. As will be understood, the frame 12 thereby forms a rigid supporting structure for the step 11 and the articulated mechanism 15 and is adapted to be fixedly mounted to the chassis of a vehicle through a fastening device at any appropriate location at which passenger ingress and egress may be needed, e.g., directly below doorways or directly below an existing sidestep. In the embodiment shown, the fastening device comprises a plurality of screws 13 that are received in corresponding holes 123 of the front transverse crossbar 122a of the main frame 12 and adapted to be screwed into corresponding threaded holes of the chassis of the vehicle. Of course, the particular manner and arrangement of fastening the frame 12 may vary from one vehicle to another as necessary to adapt or conform to the particular structure of a vehicle's chassis. Preferably, the components of the frame 12, as well as the step 11 and the individual links in the articulated mechanism 15, are fabricated of a suitable metal or alloy to provide strength and rigidity, although any other material suitably providing such qualities could be utilized.

The step 11 comprises a horizontally extending tread 111, on which one can place a foot, and an extension bracket 112 extending upward and rearward therefrom. The tread 111 is fabricated as a flat elongate metal plate of rectangular configuration to present an upwardly facing tread surface 111a, with integral front and rear flanges 111b and end brackets 111c extending downwardly in perpendicular relation from the respective edges of the tread surface 111a. As necessary or desirable, the tread surface 111a may be formed or provided with a roughened or otherwise frictional surface to limit possible slippage of a user's feet thereon. The extension bracket 112 is of a generally parallelepiped shape having an upper surface 112a that forms an angle with the tread surface 111a.

The articulated mechanism 15 comprises two identical pairs of individual support links, respectively a first pair of left support links and a second pair of right support links, arranged in spaced mirror-image relation to one another and pivotably interconnected to the extension bracket 112 at opposite sides of the frame 12 and opposite ends of the step 11. For sake of clarity, the articulated mechanism 15 will be described according to one pair of the individual links, as seen in FIGS. 6 and 8, it being understood that an identical mirror-image set of links is provided at the opposite side of the footstep assembly 10.

The articulated mechanism 15 at each side of the footstep assembly 10 comprises a pair of support links 151, 152, respectively a front support link 151 and a rear support link 152, pivotally connected at their upper ends at a horizontal spacing to the inwardly facing surfaces 121c of the end plates 121. The support links 151, 152 extend downwardly and rearward in generally parallel relation and are pivotally connected at their lower ends at a corresponding horizontal spacing to the extension bracket 112. The two pairs of support links 151, 152 in the articulated mechanism 15 are connected with one another to move in unitary coordinated manner by a connecting rod 153 rigidly fixed to each rear support link 152, the connecting rod 153 being pivotally fixed to the end plates 121 of the main frame 12. In particular, the connecting rod 153 may comprise a flat complementary with a flat formed in each rear support link 152, so that each rear support link 152 is integral in rotation with the connecting rod 153. The connecting rod 153 may be rotatably movable about a rotation axis X through a motor 16. In particular, the connecting rod 153 may form the output shaft of the motor 16, or be connected to this output shaft via a series of gears. The motor 16 may advantageously be electrically driven. However, pneumatically driven or hydraulically driven motors may also be used. In an alternative way, any other actuating means adapted to rotatably move the connecting rod 153 may be alternatively used. In this manner, the rear support links 152 act in a coordinated parallelogram-type fashion and, under the action of the motor 16, may switch the articulated mechanism 15 from a folded state, illustrated in FIGS. 5 and 6, to an unfolded state, illustrated in FIGS. 7 and 8.

The operation of the footstep assembly 10 is disclosed in detail in the below paragraphs.

When the articulated mechanism 15 is its folded state as shown in FIGS. 5 and 6, the footstep assembly 10 is in its fully retracted state, corresponding to the storage position of the step 11. This folded state of the articulated mechanism 15 may however be unstable due to the tendency of the support links 151, 152 to move closer to the ground under the effect of their weight. Therefore, to avoid an action of the motor 16 to maintain the rear support links 152 in their positions shown in FIGS. 5 and 6, the footstep assembly 10 may advantageously be provided with a magnet 18 that is adapted to interact with a metallic portion of one rear support link 152 so that the articulated mechanism 15 is kept in its folded state. In a specific embodiment, the rear support links 152 may be totally fabricated of a suitable metal. The magnet 18 may be chosen among a permanent magnet or an electromagnet. In the specific example of an electromagnet, the magnetic field disappears when the current is turned off. Therefore, the retaining action of the magnet 18 may be stopped when the articulated mechanism 15 needs to be transferred in its unfolded state.

The footstep assembly 10 may also comprise one or several sensor(s) 19, for instance an induction sensor, that is adapted to sense the current position of the step 11, in particular when the step 11 is in its storage and/or operative position(s), and transmit a corresponding signal to a controller of the footstep assembly 10. In response to said signal, the controller may control the motor 16 to stop the rotary motion of the connecting rod 153, thus avoiding any deterioration of the articulated mechanism 15 due to excessive folding or unfolding of the support links 151, 152.

Upon application of a torque to the connecting rod 153 through the motor 16, the articulated mechanism 15 begins to pivot forwardly with pivoting movement of the support links 151, 152 and the extension bracket 112 to swing the tread 111 forwardly and downwardly into a horizontal disposition vertically offset from the frame 12. At the completion of such movement, the motor 16 stops applying a torque to the connecting rod 153. This stop may be determined and controlled by the controller based on the signal received from the sensor(s) 19. Following use, the footstep assembly 10 can be retracted from this extended disposition by reversing the described sequence of steps.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A footstep assembly for a vehicle, such as a truck, comprising:
a main frame configured to be coupled on a chassis of the vehicle;
a fastening device adapted to fasten the main frame to the chassis of the vehicle, preferably directly below an existing sidestep of the vehicle;
at least one step hingedly connected to the main frame through an articulated mechanism, the articulated mechanism having a folded state, in which the at least one step is in a storage position, in which it is aligned in a first horizontal plane, and an unfolded state, in which the at least one step is in an operative position, in which it is aligned in second horizontal plane that is below the first horizontal plane and vertically offset therefrom;
an actuator configured to switch the articulated mechanism between its folded state and its unfolded state; and
a controller adapted to control the actuator.

2. The footstep assembly of claim 1, wherein the at least one step comprises a tread, on which one can place a foot, and an extension bracket extending rearward therefrom and the articulated mechanism comprises a parallelogram arrangement comprising two pairs of support links, respectively a first pair of front support links and a second pair of rear support links, the front, respectively the rear, support links being pivotally fixed at their upper ends to the main frame and at their lower ends to the extension bracket.

3. The footstep assembly of claim 2, wherein the rear support links are fixedly connected to a connecting rod pivotally fixed to the main frame, the connecting rod being rotatably movable about a rotation axis through a motor.

4. The footstep assembly of claim 3, wherein the motor is electric.

5. The footstep assembly of claim 1, further comprising at least one sensor adapted to sense the current position of the at least one step and transmit a corresponding signal to the controller so that the controller stops the actuator when the at least one step is in its storage and/or operative position(s).

6. The footstep assembly of claim 1, further comprising a magnet adapted to interact with a metallic portion of the articulated mechanism when the at least one step is in its storage position so that the articulated mechanism is kept in its folded state.

7. The footstep assembly of claim 1, wherein the fastening device comprises a plurality of screws that are received in corresponding holes of the main frame and adapted to be screwed into corresponding threaded holes of the chassis of the vehicle.

8. The footstep assembly of claim 1, wherein the controller is adapted to be electrically connected to an electronic control unit of the vehicle so as to receive control signals therefrom.

9. The footstep assembly of claim 8, wherein the controller is adapted to switch the articulated mechanism from its folded state to its unfolded state when it receives a specific control signal from the electronic control unit of the vehicle.

10. A vehicle comprising:
an electronic control unit;
a cab including at least one cab door and at least one side footstep below the at least one cab door;
a door sensor adapted to sense an opening state of the at least one cab door and transmit a corresponding signal to the electronic control unit; and
the footstep assembly of claim 9 mounted on the at least one side footstep;
wherein the electronic control unit is adapted to transmit a specific control signal to the controller of the footstep assembly when it receives a signal from the door sensor when the at least one cab door opens, thus moving the at least one step of the footstep assembly from its storage position to its operative position.
